(19) United States
(12) Patent Application Publication
(10) Pub. No.: US 2026/0170553 A1
(43) Pub. Date: Jun. 18, 2026

(54) Method and Apparatus for Recording Transactions Against Accounts in an Account Database

(71) Applicant: Telefonaktiebolaget LM Ericsson (publ), Stockholm (SE)

(72) Inventors: Elisabeth Adelgren, Hagby (SE); Magnus Söderlund, Lyckeby (SE)

(21) Appl. No.: 19/125,197

(22) PCT Filed: Nov. 2, 2022
(86) PCT No.: PCT/SE2022/051006

§ 371 Date: Apr. 28, 2025

(51) Int. Cl. G06Q 40/02; G06Q 20/38

(52) U.S. Cl. CPC G06Q 40/0222; G06Q 20/389

(57) ABSTRACT

An account management system (10) and a corresponding method (500) of account management record transactions against accounts (26) in an account database (24) and, in particular, conditionally use an advantageous delta logging procedure for recordation. Delta logging does not update the account balance and does not require account locking and, as such, the use of delta logging improves the performance of the account management system (10), without compromising accuracy, reliability, and traceability of transaction recordation.

### TECHNICAL FIELD

An account management system and a corresponding method of account management record transactions against accounts in an account database and, in particular, conditionally use an advantageous delta logging procedure for recordation.

### BACKGROUND

Account management systems operate according to requirements that are oftentimes challenging to meet. Maintaining accurate account balances stands as an obvious requirement, meaning that account management systems must provide reliable, accurate recordation of transactions against accounts in an account database. Other requirements are less obvious, or it may be said that the mechanisms needed to meet other requirements are not obvious. For example, the requirement for an account management system to support some minimum number of transactions per second appears straightforward but meeting that requirement may not be straightforward, at least in certain contexts.

Consider, for example, circumstances where many transactions target the same account, such as where commissions from multiple sales staff are credited against a common account. Or, as another example, consider an account that is charged for usage of communication network resources by individual devices within a population of network-connected devices. While scheduling network accesses among the population goes some way towards mitigating the need to process many transactions within a short interval or the need to process concurrent transaction, such scenarios may unavoidably tax the performance capabilities of the account management system.

Other complications arise in terms of the account types and applicable regulatory and legal requirements. In this regard, an “account” in general terms is a persistent electronic record that holds or is linked to account holder information and contains a stored value that is incremented or decremented to reflect transactions conducted against the account. One example is financial accounts, e.g., bank accounts, where the stored value is monetary. A multiplicity of regulatory and legal requirements applies with respect to maintaining accurate account balances, recording transactions, observing applicable lower or upper limits, flagging suspicious transactions, and reporting certain types of transactions to regulatory or taxing or legal authorities.

Another example suggested above is an account used to support a population of entities, e.g., a population of smart electrical meters, a population of vehicles, etc., where the individual entities in the population all consume a service or otherwise carry on activities that generate transactions against the account. As a specific example, consider a population of Internet-of-Things (IoT) devices that use a cellular network as an access network for communicating with one another or with a remote server that logs data from them or otherwise provides a service to them. A supporting account contains monetary units or consumption units, for example, with each access by one of the IoT devices resulting in a transaction against the account that decrements some fixed or variable number of units from the account. With each IoT device possibly performing multiple accesses within a short interval of time, there may be hundreds or even many thousands of transactions incoming to the supporting account management system per second, all targeting the same account. Further, the account management system may manage multiple such accounts.

### SUMMARY

An account management system and a corresponding method of account management record transactions against accounts in an account database and, in particular, conditionally use an advantageous delta logging procedure for recordation. Delta logging does not update the account balance and does not require account locking and, as such, the use of delta logging improves the performance of the account management system, without compromising accuracy, reliability, and traceability of transaction recordation.

An example embodiment comprises a method of updating accounts in an account database, with the method performed by a computer system having access to the account database. The method includes receiving electronic signaling identifying an account in the account database and indicating a transaction for recordation against the account and further includes determining whether to record the transaction against the account using a delta logging procedure that does not lock the account against concurrent transactions or a balance updating procedure that locks the account against concurrent transactions. The decision-making is based on at least one of: determining whether the transaction is a candidate for use of the delta logging procedure, based on evaluating one or more attributes of the transaction or determining whether the account satisfies one or more conditions for use of the delta logging procedure. Responsive to determining to record the transaction using the delta logging procedure, the method includes performing the delta logging procedure. The delta logging procedure comprises recording a change value against the account in the account database without updating an account balance of the account, for later reconciliation of the account balance.

Another embodiment comprises a computer system that is configured for updating accounts in an account database. The computer system has access to the account database and includes interface circuitry and processing circuitry. The processing circuitry is configured to: receive, via the interface circuitry, electronic signaling identifying an account in the account database and indicating a transaction for recordation against the account; and determine whether to record the transaction against the account using a delta logging procedure that does not lock the account against concurrent transactions or a balance updating procedure that locks the account against concurrent transactions. The processing circuitry is configured to base the decision on at least one of: determining whether the transaction is a candidate for use of the delta logging procedure, based on evaluating one or more attributes of the transaction or determining whether the account satisfies one or more conditions for use of the delta logging procedure. Thus, the processing circuitry is configured to perform the delta logging procedure on a conditional basis, based on the aforementioned decision making. As noted, the delta logging procedure comprises recording a change value against the account in the account database without updating an account balance of the account, for later reconciliation of the account balance.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a system according to an example embodiment, where the system includes a computer server for recording transactions against accounts in an account database.

FIGS. 2-4 are block diagrams of details for the computer server of FIG. 1, according to example embodiments.

FIG. 5 is a logic flow diagram of a method of operation by a computer server for recording transactions against accounts in an account database, according to an example embodiment.

FIG. 6 is a logic flow diagram of example details for one aspect of the method depicted in FIG. 5.

FIG. 7 is a logic flow diagram of a method of operation by a computer server for recording transactions against accounts in an account database, according to another example embodiment.

### DETAILED DESCRIPTION

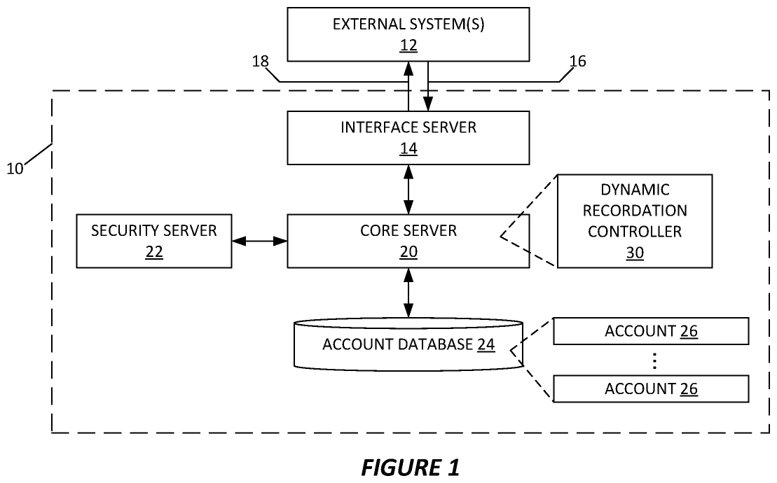

FIG. 1 illustrates an overall account management system 10 that communicates with one or more external systems 12. Example external systems 12 include, without suggesting any limitations, external accounting or billing systems, such the accounting or billing systems of any one or more of financial services providers, telecommunications network operators, Internet or other network service providers, multimedia content providers, etc.

The account management system 10 includes an interface server 14 that exchanges signaling with the external system(s) 12. For example, incoming signaling 16 includes transaction signaling indicating transactions for recordation against identified accounts managed by the account management system 10. Outgoing signaling 18 includes corresponding responses and/or outgoing transaction signaling, indicating external accounts, and corresponding transaction information.

The account management system 10 further includes a core server 20 that performs one or more aspects of account management, a security server 22 that performs security-related operations, and an account database 24 that holds records representing individual accounts 26. Other arrangements are possible for supporting and performing the account management techniques disclosed herein. For example, the two or more of the illustrated servers may be consolidated into one server that provides the respective functions. Correspondingly, the core server 20 may also be referred to as a computer server 20 or computer system 20. Hereafter, the more general term “computer system” is used.

However it may be arranged, the computer system 20 is configured for account management and includes, according to the disclosed techniques, a dynamic recordation controller 30 that improves the performance of an account management system by making dynamic control decisions about how to record transactions against individual accounts 26 held in the account database 24. Here, the phrase “dynamic recordation controller” refers to specific functionality realized via underlying processing circuitry.

As a particular technical improvement over existing account-management computer systems and methods, dynamic recordation control comprises determining, for a given transaction involving a given account 26, whether to record the transaction against the account 26 using a delta logging procedure that does not lock the account 26 against concurrent transactions or a balance updating procedure that locks the account 26 against concurrent transactions. Viewed another way, dynamic recordation control is a technique that avoids performing account locking and balance updating at instances where the change in account value arising from a transaction directed to an account may be recorded as a delta change without need for locking the account. Of course, an important aspect of such improvements is assessing whether delta recording is appropriate. The techniques disclosed herein allow for use of dynamic recordation control and selective performance of the delta logging procedure in a manner that does not compromise any legal and/or logical limits or thresholds applicable to the involved accounts.

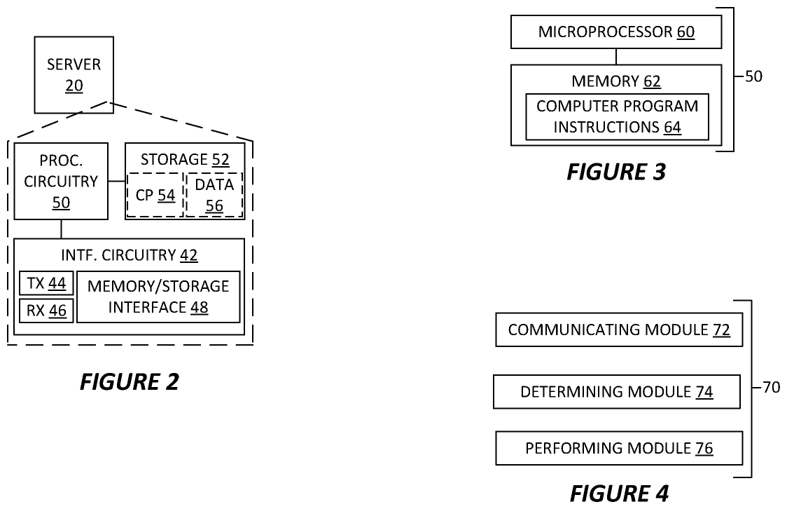

FIG. 2 illustrates an example implementation of a computer system 20 configured for dynamic recordation control in the context of performing account management with respect to individual accounts 26 held in an account database 24 that is stored in or otherwise accessible to the computer system 20. Among the entities included in the computer system 20 is interface circuitry 42. In the example embodiment, the interface circuitry 42 comprises physical-layer circuitry, such as physical-layer transmitter (TX) and receiver (RX) circuitry 44 and 46, or multiple TX/RX circuits, for receiving incoming transaction signaling 16 and transmitting outgoing transaction signaling 18. As an example, the TX/RX circuitry 44/46 comprises one or more Ethernet interfaces or other computer-networking interfaces for coupling to the external system(s) 12, e.g., via an Internet or other Packet Data Network (PDN) connection. Additionally, or alternatively, the interface circuitry 42 comprises one or more memory or storage interfaces 48, e.g., a computer data bus providing access to memory and/or storage that contains any one or more of transaction information and the account database 24.

Processing circuitry 50 is operatively associated with the interface circuitry 42, meaning that the processing circuitry 50 uses the interface circuitry 42 to transmit and receive transaction signaling and to access one or more account databases 24. The processing circuitry 50 includes or is associated with storage 52, which comprises one or more types of computer-readable media, such as memory or other storage circuits or devices. Non-limiting examples of the storage 52 include any one or more of SRAM, DRAM, FLASH, EEPROM, Solid State Disk (SSD), etc. Broadly, the storage 52 may include volatile memory for program execution and non-volatile memory for longer-term storage.

In at least one embodiment, the storage 52 stores computer program instructions in the form of one or more computer programs 54 and may store one or more items of data 56. Stored data comprises, for example, configuration data that includes limits, qualifiers, conditionals, etc., that control the basis for deciding on a dynamic basis whether a given transaction is eligible for recording using a delta logging procedure that does not lock the account or should be recorded using a balance updating procedure that does lock the account.

An example implementation of the processing circuitry 50 appears in FIG. 3, wherein the processing circuitry 50 comprises a microprocessor 60 that is specially adapted to operate as the processing circuitry 50 based on executing computer program instructions 64 stored in a memory 62. The memory 62 may comprise or be part of the storage 52 and the computer program instructions 64 may comprise or be part of the one or more computer programs 54.

With the above in mind, in an example embodiment, a computer system 20 is configured for updating accounts 26 in an account database 24, wherein the computer system 20 has access to the account database 24, e.g., either locally or via communicative coupling to a remote location of the account database 24. The computer system 20 includes interface circuitry 42 and processing circuitry 50.

The processing circuitry 50 is configured to receive, via the interface circuitry 42, electronic signaling identifying an account 26 in the account database 24 and indicating a transaction for recordation against the account 26. Further, the processing circuitry 50 is configured to determine whether to record the transaction against the account 26 using a delta logging procedure that does not lock the account 26 against concurrent transactions or a balance updating procedure that locks the account 26 against concurrent transactions. In an example arrangement, the determination is based on at least one of: determining whether the transaction is a candidate for use of the delta logging procedure, based on evaluating one or more attributes of the transaction, or determining whether the account satisfies one or more conditions for use of the delta logging procedure.

Still further, the processing circuitry 50 is configured to use the delta logging procedure, responsive to determining to record the transaction using the delta logging procedure. Performing the delta logging procedure comprises recording a change value against the account 26 in the account database 24 without updating an account balance of the account 26, for later reconciliation of the account balance. As an example, the delta logging procedure entails the processing circuitry 50 storing the change value in a different column or table as compared to the column or table in the account database 24 that holds the account balance of the account 26. More generally, the change value may be written as a data value that is associated with or linked to the account 26 but does not change the account 26. Instead, a later reconciliation procedure updates the account 26 to reflect the then-recorded change values that are outstanding against the account 26.

In at least one embodiment, multiple instances of the delta logging procedure may be run concurrently—i.e., wholly or partially overlapping in time—against the same account 26. This approach allows a potentially high number of different transactions to be recorded against the same account 26 at the same time or at overlapping times, without account locking or blocking. As such, the computer server 20 improves its transactions-per-second performance and certain operating scenarios become feasible that otherwise would cause performance bottlenecks. For example, consider a scenario where a single account 26 is associated with many transaction originators, e.g., where a potentially large population of IoT devices each carry on network communications that trigger “charging” or “debiting” transactions against the same account 26.

Using conventional recordation, each transaction requires temporarily locking the account to block conflicting account updates, updating the account balance, and then unlocking the account. Such locking greatly complicates or even forecloses simultaneous transaction processing against the same account. In contrast, the delta logging procedure provides a mechanism for processing multiple transactions against the same account at the same time or at overlapping times.

Moreover, by conditioning performance of the delta-logging procedure on the satisfaction of one or more conditions, the computer system 20 ensures that use of the delta logging procedure is restricted to conditions and transactions for which it is appropriate. For example, in at least one embodiment, the processing circuitry 50 is configured to determine whether an account 26 satisfies the one or more conditions for use of the delta logging procedure by determining whether there is at least a threshold distance between the account balance of the account 26 and a defined account limit. In the same embodiment or in at least one other embodiment, the processing circuitry 50 is configured to determine whether the account 26 satisfies the one or more conditions for use of the delta logging procedure by determining whether the credit or debit value of the transaction is less than a defined percentage of the account balance, i.e., the current account balance including the stored delta log entries. Additionally, or alternatively, the processing circuitry 50 is configured to determine whether the account 26 satisfies the one or more conditions for use of the delta logging procedure by determining whether a current number of recorded change values for the account 26 is below a defined number.

With respect to the processing circuitry 50 being configured to determine whether a transaction is a candidate for use of the delta logging procedure and/or whether the account 26 targeted by the transaction satisfies the one or more conditions for use of the delta logging procedure, consider an example operational instance where the processing circuitry 50 determines that the transaction is a candidate for use of the delta logging procedure but determines that the account 26 does not satisfy the one or more conditions for use of the delta logging procedure. According to its configuration in at least one embodiment, the processing circuitry 50, responds by computing an updated account balance to reflect any recorded change values in the account 26, along with the change value of the transaction, and updating the account balance to the updated account balance.

That is, the processing circuitry 50 may make an initial determination that a given transaction is a candidate for delta logging and hence not invoke the balance updating procedure and, therefore, not lock the account 26. Rather, the processing circuitry 50 proceeds to check whether one or more conditions associated with the account 26 allow for use of the delta logging procedure. If so, the processing circuitry 50 initiates the delta logging procedure but, if not, the processing circuitry 50 performs what might be considered a hybrid procedure.

In this hybrid procedure, the processing circuitry 50 determines an updated account balance based on the change value of the transaction and any change values already recorded against the account, and then it checks whether the account 26 has been modified or locked for a concurrent transaction. If not, the processing circuitry 50 records the updated account balance into the account balance field of the account 26 and clears the recorded delta changes accounted for in the updated account balance. If, however, the processing circuitry 50 detects a transaction concurrent with the hybrid procedure, the processing circuitry 50 aborts the update, leaving the account data unmodified and re-attempts recordation of the transaction. The processing circuitry 50 detects the concurrent transaction by, for example, detecting that the account lock has been set, or by detecting that a flag indicating an ongoing transaction has been set.

The processing circuitry 50 is configured to lock the account 26 against concurrent transactions in response to determining to record the transaction using the balance updating procedure. The processing circuitry 50 performs the balance updating procedure with the account locked, and the procedure includes updating the account balance of the account 26 to reflect the change value of the transaction, and then unlocking the account 26. The balance updating procedure in one or more embodiments includes updating the account balance to reflect not only the change value of the current transaction—i.e., the transaction that triggered invocation of the balance updating procedure, but also any recorded change values then present in the account database 24 for the involved account 26. Of course, for any recorded change value that is reconciled, the processing circuitry 50 deletes that change value from the queue or other data structure used to hold unreconciled change values for the account 26, and any accounting information, such as dates, times, amounts, parties, etc., are recorded or saved, as needed.

As for the processing circuitry 50 being configured to determine whether a given transaction is a candidate for use of the delta logging procedure, in one or more embodiments, the processing circuitry 50 is configured to determine whether a type of the transaction matches one or more transaction types for which use of the delta logging procedure is disallowed. Account opening transactions and/or account closing transactions are examples of transaction types for which the delta logging procedure is disallowed, and for which the balance updating procedure must be used. Of course, the delta logging procedure may be disallowed for a given transaction for one or more reasons. For example, the processing circuitry 50 detects that the value of the transaction exceeds a defined limit. As another example, the account targeted by the transaction may be too close to an upper balance limit or a lower balance limit. As another example, there may be too many unreconciled change values already recorded for the account. In this regard, in one or more embodiments, the processing circuitry 50 is configured to reconcile account balances periodically. Periodic reconciliation means that, for individual accounts 26 in the account database 24 that have recorded change values, the processing circuitry 50 updates each such account 26 by adjusting the account balance to incorporate the recorded change values and correspondingly clearing the recorded change values.

FIG. 4 illustrates another embodiment of the computer system 20, realized as a set 70 of processing units or functional modules. These units or modules may be instantiated in a virtualized environment, but it should be understood that the units or modules are realized using underlying processing circuitry. In an example module arrangement, the computer system 20 includes a communicating module 72, a determining module 74, and a performing module 76.

The communicating module 72 is configured to receive electronic signaling identifying an account 26 in an account database 24 and indicating a transaction for recordation against the account 26. The determining module 74 is configured to determine whether to record the transaction against the account 26 using a delta logging procedure that does not lock the account 26 against concurrent transactions or a balance updating procedure that locks the account 26 against concurrent transactions. The decision is based on at least one of: determining whether the transaction is a candidate for use of the delta logging procedure, based on evaluating one or more attributes of the transaction, or determining whether the account satisfies one or more conditions for use of the delta logging procedure. Responsive to determining to record the transaction using the delta logging procedure, the performing module 76 performs the delta logging procedure.

As a reiteration, the delta logging procedure (1) does not lock the account 26 against concurrent transactions and (2) does not update the account balance. Instead, the delta logging procedure records the change value of the transaction for later reconciliation. Such recordation comprises, for example, writing in a table or column in the account database 24 that is different than the account-balance table or column. More broadly, the delta logging procedure can be understood as making a record entry that does not interfere with the account balance record. For example, assume an account with a balance of “100” where “100” may be monetary units or other units. Now assume two separate debits or withdrawals of 10 units each, with the delta logging procedure used to record the withdrawals. The recorded balance of the account would remain 100 units, but a linked delta-logging table would include two entries of −10 units for each withdrawal. Thus, the processing circuitry 50 would perform a balance read as, for example, “getAccountBalance+getAccountDeltas”. The getAccountBalance access read would return 100 units as the currently-recorded account balance and the getAccountDeltas read would return −20 units as the total value of the outstanding (unreconciled) deltas, meaning that the balance read would correctly indicate the actual account balance as 80 units.

Unlike the delta logging procedure, the balance updating procedure (1) locks the account 26 against concurrent transactions and (2) updates the account balance—i.e., overwrites the existing account balance with an updated value reflecting the incremental change caused by the transaction. The change is a debit value or a credit value, for example, where the debiting or crediting is based on whatever “units” are used to represent the account balance. Again, example units include monetary units or service units, which also may be referred to as consumption units. Example service units include, for example minutes or megabytes, which may be consumed in conjunction with a given electronic device consuming one or more types of network services.

As a variant of the two procedures, the aforementioned hybrid procedure may be used in a case where the processing circuitry 50 identifies a transaction as being suitable for use of the delta logging procedure and therefore not invoking account locking, but then detecting that one or more conditions bearing on the involved account 26 make use of the delta logging procedure inappropriate. In such a case, the processing circuitry 50 effectively performs the hybrid procedure, which can be understood as a conditional balance updating procedure without account locking. Namely, the processing circuitry reconciles the change value of the triggering transaction and any unreconciled change values pending against the account 26, and then attempts to overwrite the account balance of the account 26. The processing circuitry 50 performs the overwriting if it does not detect any concurrent transactions involving the account 26 and otherwise aborts the overwriting and reattempts recordation of the transaction. Of course, aborting means discarding the change-value reconciliations, such that the unrecorded changes values are left undisturbed.

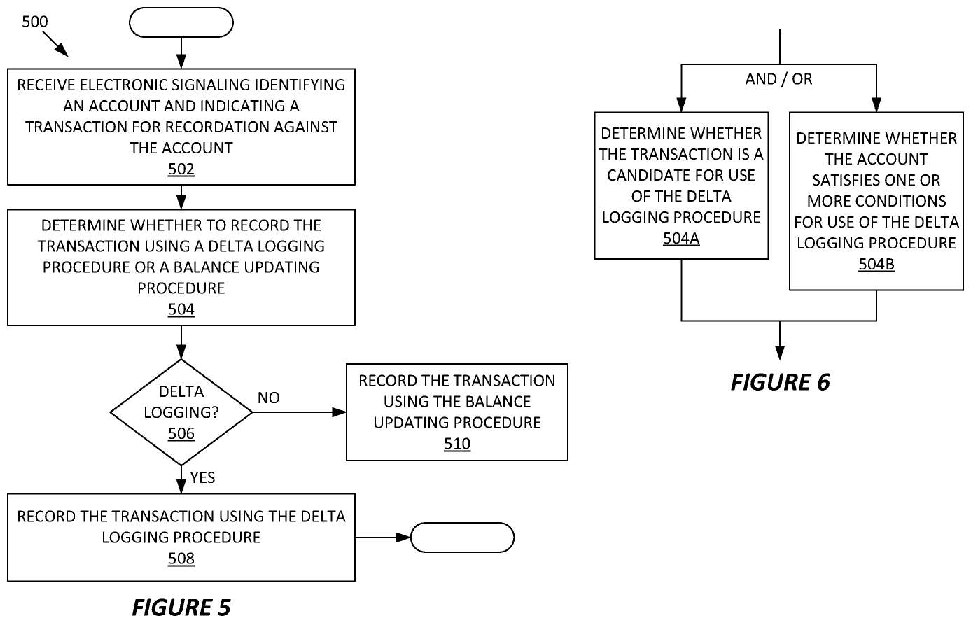

FIG. 5 illustrates a method 500 of updating accounts 26 in an account database 24, where a computer system 20 having access to the account database 24 performs the method. Operations include receiving (Block 502) electronic signaling identifying an account 26 in the account database 24 and indicating a transaction for recordation against the account 26 and determining (Block 504) whether to record the transaction against the account 26 using a delta logging procedure that does not lock the account 26 against concurrent transactions or a balance updating procedure that locks the account 26 against concurrent transactions. With further reference to FIG. 6, the determination of whether to use the delta logging procedure or the balance updating procedure is based on at least one of: determining (Block 504A) whether the transaction is a candidate for use of the delta logging procedure, based on evaluating one or more attributes of the transaction or determining (Block 504B) whether the account satisfies one or more conditions for use of the delta logging procedure.

Responsive to determining to record the transaction using the delta logging procedure (YES from Block 506), the method 500 proceeds with performing (Block 508) the delta logging procedure. As explained earlier, the delta logging procedure comprises recording a change value against the account 26 in the account database 24 without updating an account balance of the account 26, for later reconciliation of the account balance. Alternatively, responsive to determining not to use the delta logging procedure (NO from Block 506), the method 500 proceeds with performing (Block 510) recording the transaction using the balance updating procedure. As explained earlier, the balance updating procedure locks the account 26 against concurrent transactions—i.e., it blocks the performance of further delta logging or balance updating procedures against the account 26 for the period of time spanned by the balance updating procedure—and it results in updating the account balance of the account 26.

Determining (Block 504B) whether an account 26 satisfies the one or more conditions for use of the delta logging procedure comprises, for example, any one or more of: determining whether there is at least a threshold distance between the account balance of the account 26 and a defined account limit; determining whether the credit or debit value of the transaction is less than a defined percentage of the account balance; and determining whether a current number of recorded change values for the account 26 is below a defined number.

In an example scenario, the computer system 20 determines that a transaction is a candidate for recording using the delta logging procedure and it thus decides not to use the balance updating procedure. However, if the computer system 20 determines that the involved account 26 does not satisfy one or more conditions for use of the delta logging procedure, it may use the hybrid updating procedure described previously; namely, the computer system attempts to update the account balance of the account 26 to reflect the change value of the transaction and any change values currently recorded against the account 26, but it does so without locking the account 26. However, it conditions the updating on not detecting a concurrent transaction involving the account 26, and, in response to detecting a concurrent transaction, it aborts the updating of the account balance and restarts recordation of the transaction against the account 26.

Determining (Block 504A) whether a transaction is a candidate for use of the delta logging procedure comprises, for example, any one or more of: determining whether a type of the transaction matches one or more transaction types for which use of the delta logging procedure is disallowed; or determining whether the change value of the transaction exceeds a defined amount.

The method 500 in one or more embodiments further includes periodically reconciling account balances. The periodic reconciliation comprises, for individual accounts 26 in an account database 24 that have recorded change values, the computer system 20 updating each such account 26 by adjusting the account balance to incorporate the recorded change values and correspondingly clearing the recorded change values. Periodic reconciliation prevents the accumulation of an excessive number of recorded change values against any given account 26. Doing so reflects the fact that while individual change values recorded against an account 26 may be a small fraction of the account balance, they collectively represent a more significant fraction of the account balance and, beyond a certain number, ought to be reflected in the account balance. In one example, the computer system 20 follows a rule wherein it does not use the delta logging procedure for any account that has more than ten change values recorded against it, and it periodically reconciles recorded change values to clear them.

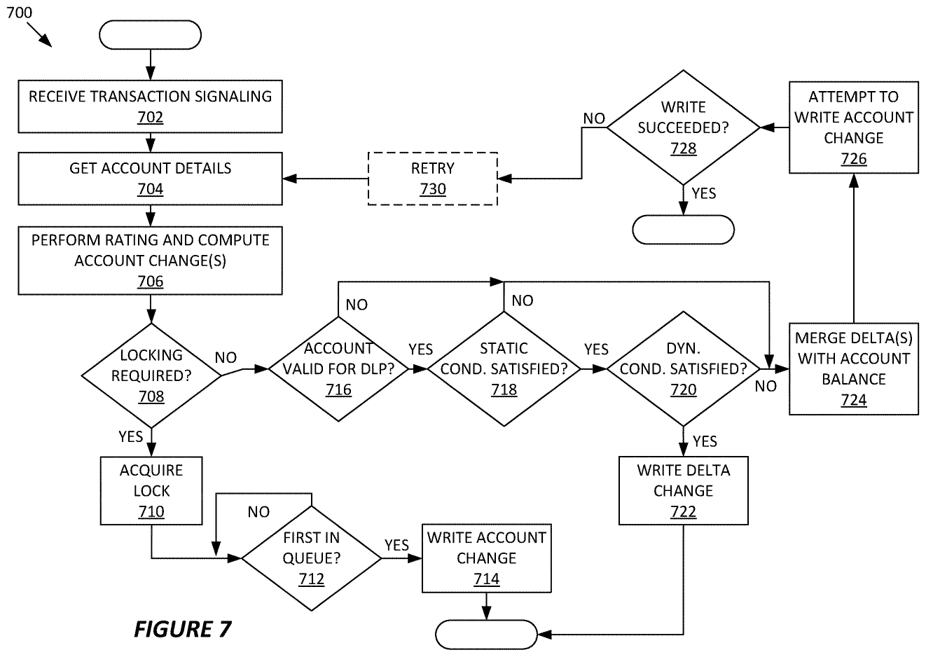

FIG. 7 illustrates a method 700 according to one or more embodiments. Processing includes a computer system 20 receiving (Block 702) transaction signaling that identifies a targeted account 26 in an account database 24. The computer system 20 gets account details (Block 704) from the account database 24 and any supporting data sources, such as subscriber records, and performs (Block 706) rating and computes the account changes. Here, “rating” refers to determining the value of the transaction in terms of the units used to denominate the account balance.

In one example, the account balance is expressed in monetary units, the transaction signaling indicates a certain amount of consumption of communication services or network services, and the rating operation converts the consumption into monetary units. In other instances, rating does not necessarily involve any units conversion, but may include applying promotional or contracted discounts, etc. The operations in Block 706 may further include determining whether there are any associated fees, tax withholdings, commissions, etc., that must be reflected in the transaction value.

Operations continue with determining whether locking is required (Block 708). For example, the computer system 20 determines whether delta logging is allowed or appropriate for the transaction and, if not (YES from Block 708), processing continues with acquiring an account lock (Block 710) and performing the balance updating procedure (Blocks 712 and 714). Note that there may be ongoing or queued balance updating procedures for the account 26, such that the locking and writing are deferred until the transaction at issue becomes first in a pending balance-updating queue.

However, if the computer system 20 determines that the transaction does not necessitate account locking (NO from Block 708), processing continues with evaluating whether one or more account conditions for using delta logging are satisfied. For example, some types of accounts 26 or some particular accounts 26 may never be suitable for use of the delta logging procedure (Block 716). If the account 26 is valid for use of the delta logging procedure, processing continues with evaluating one or more static conditions and one or more dynamic conditions that must be satisfied for use of the delta logging procedure (Blocks 718, 720). If all such conditions are satisfied (YES from each of Blocks 716, 718, and 720), processing continues with writing the delta change (Block 722), which can be understood as performing the delta logging procedure.

If any of the conditions are not satisfied (NO from any of Blocks 716, 718, and 720), processing continues with the processing shown in Blocks 724, 726, 728, and 730, which can be understood as the hybrid procedure described earlier. In more detail, the account 26 is not locked for performance of the hybrid procedure, which includes merging (Block 724) the change value of the transaction and any recorded change values then present for the account 26 with the account balance of the account 26. Note that this operation uses “shadow” values or can be considered as pending in the sense that the existing account balance is not yet overwritten with the updated account balance computed in Block 724. Of course, as noted, the recorded change values are accounted for when checking the available balance in an account 26.

Instead, as shown in Block 726, the computer system 20 attempts to write the updated account balance to the account 26, with the attempt predicated on the computer system 20 detecting no concurrent transactions for the account 26. For example, the computer system 20 remembers the account state from Blocks 706/708 and compares that state to the current state of the account 26, as checked again in Block 726. No change in state indicates that no other transactions have been initiated against the account 26 during the processing interval from Blocks 706/708 to Block 726. Example state changes include, for example, a lock flag for the account 26 going from a cleared state to a set state. Of course, evaluating state change may be more complex, such as looking whether there has been a change in the account balance, or a change in a hash value calculated from the state of the account 26.

If no state change is detected, the write is executed, meaning that the updated account balance is committed to the account 26 and the hybrid procedure concludes (YES from Block 728). However, if a state change is detected, the write is not executed and the account 26 is left undisturbed (NO from Block 728) and a retry procedure (Block 730) is initiated, which returns processing to Block 704. In other words, if the hybrid procedure fails, such as would happen if another instance of the hybrid procedure is in process for the same account 26, meaning that the transaction is not recorded against the account 26, the computer system 20 retries recordation using the above described processing flow.

From the above example details, it shall be understood that a computer system may be configured to base its decision on how to record a given transaction against a given account 26 based on a number of characteristics of the transaction, the account 26, and even the account holder. Here, “how” to record a transaction refers to deciding whether to use the balance updating procedure with account locking or the delta logging procedure without account locking. Example characteristics include: how close to the limits the current account balance is; the size of the transaction, the number of change values currently recorded against the account 26, the profile of the account holder—for example, the profile reflects any one or more of credit score, permissions, subscriptions, etc.; the type of operation(s) involved in the transaction, e.g., does the transaction involve transfer to an external account versus transfer between accounts 26 that are both “internal” accounts.

One approach advantageously divides characteristics into two types—dynamic or semi-static. Examples of semi-static characteristics are the status of account holder or details in account holder profile. Semi-static characteristics are updated at most once a day but more commonly not more than once a month or year. Dynamic characteristics in contrast have values that change more often or are part of individual transactions. For example, the transaction size is a dynamic characteristic. Semi-static characteristics may be evaluated and combined into a trust level, that is kept in memory and updated according to a schedule, such as once a day or triggered whenever an administrative operation touches any of the characteristics that forms the trust level. Combining potentially several characteristics into a trust level and using the trust level for runtime decision making increases the decision-making speed and, therefore, improves overall performance of ongoing account management. Of course, the dynamic characteristics are necessarily evaluated for every transaction.

In an example financial context, when a financial request is handled and after the required routing, authentication and authorization logic is performed, the transaction is divided into sub transactions, one for each account holder involved in the request. As part of handling each sub transaction of the request in an account management system 10 as shown in FIG. 1, the dynamic recordation controller 30 represents that processing circuitry/functional logic by which the account management system 10 decides to record individual sub transactions using the delta logging procedure or the balance updating procedure.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-20. (canceled)

21. A method of updating accounts in an account database, the method performed by a computer system having access to the account database and comprising:
receiving electronic signaling identifying an account in the account database and indicating a transaction for recordation against the account; and
determining whether to record the transaction against the account using a delta logging procedure that does not lock the account against concurrent transactions or a balance updating procedure that locks the account against concurrent transactions, based on at least one of:
determining whether the transaction is a candidate for use of the delta logging procedure, based on evaluating one or more attributes of the transaction; or
determining whether the account satisfies one or more conditions for use of the delta logging procedure; and
responsive to determining to record the transaction using the delta logging procedure, performing the delta logging procedure, which comprises recording a change value against the account in the account database without updating an account balance of the account, for later reconciliation of the account balance.

22. The method according to claim 21, further comprising periodically reconciling account balances by, for individual accounts in the account database that have recorded change values, updating each such account by adjusting the account balance to incorporate the recorded change values and correspondingly clearing the recorded change values.

23. The method according to claim 21, wherein determining whether the account satisfies the one or more conditions for use of the delta logging procedure comprises determining whether there is at least a threshold distance between the account balance of the account and a defined account limit.

24. The method according to claim 21, wherein determining whether the account satisfies the one or more conditions for use of the delta logging procedure comprises determining whether the credit or debit value of the transaction is less than a defined percentage of the account balance.

25. The method according to claim 21, wherein determining whether the account satisfies the one or more conditions for use of the delta logging procedure comprises determining whether a current number of recorded change values for the account is below a defined number.

26. The method according to claim 21, wherein responsive to determining that the transaction is a candidate for use of the delta logging procedure in conjunction with determining that the account does not satisfy the one or more conditions for use of the delta logging procedure, computing an updated account balance to reflect any recorded change values in the account, along with the change value of the transaction, and updating the account balance to the updated account balance.

27. The method according to claim 26, wherein updating the account balance comprises updating the account balance conditioned on not detecting a concurrent transaction involving the account, and, in response to detecting a concurrent transaction, aborting updating of the account balance and restarting recordation of the transaction against the account.

28. The method according to claim 21, wherein, responsive to determining to record the transaction using the balance updating procedure, the method comprises locking the account against concurrent transactions, performing the balance updating procedure, in which the account balance of the account is updated to reflect the change value of the transaction, and then unlocking the account.

29. The method according to claim 21, wherein determining whether the transaction is a candidate for use of the delta logging procedure comprises determining whether a type of the transaction matches one or more transaction types for which use of the delta logging procedure is disallowed.

30. The method according to claim 21, wherein determining whether the transaction is a candidate for use of the delta logging procedure comprises determining whether the change value of the transaction exceeds a defined amount.

31. A computer system configured for updating accounts in an account database, the computer system having access to the account database and comprising:
interface circuitry; and
processing circuitry configured to:
receive, via the interface circuitry, electronic signaling identifying an account in the account database and indicating a transaction for recordation against the account; and
determine whether to record the transaction against the account using a delta logging procedure that does not lock the account against concurrent transactions or a balance updating procedure that locks the account against concurrent transactions, based on at least one of:
determining whether the transaction is a candidate for use of the delta logging procedure, based on evaluating one or more attributes of the transaction; or
determining whether the account satisfies one or more conditions for use of the delta logging procedure; and
responsive to determining to record the transaction using the delta logging procedure, perform the delta logging procedure, which comprises recording a change value against the account in the account database without updating an account balance of the account, for later reconciliation of the account balance.

32. The computer server according to claim 31, wherein the processing circuitry is further configured to reconcile account balances periodically, by, for individual accounts in the account database that have recorded change values, updating each such account by adjusting the account balance to incorporate the recorded change values and correspondingly clearing the recorded change values.

33. The computer server according to claim 31, wherein the processing circuitry is configured to determine whether the account satisfies the one or more conditions for use of the delta logging procedure by determining whether there is at least a threshold distance between the account balance of the account and a defined account limit.

34. The computer server according to claim 31, wherein the processing circuitry is configured to determine whether the account satisfies the one or more conditions for use of the delta logging procedure by determining whether the credit or debit value of the transaction is less than a defined percentage of the account balance.

35. The computer server according to claim 31, wherein the processing circuitry is configured to determine whether the account satisfies the one or more conditions for use of the delta logging procedure by determining whether a current number of recorded change values for the account is below a defined number.

36. The computer server according to claim 31, wherein, with respect to the processing circuitry determining that the transaction is a candidate for use of the delta logging procedure in conjunction with the processing circuitry determining that the account does not satisfy the one or more conditions for use of the delta logging procedure, the processing circuitry is configured to compute an updated account balance to reflect any recorded change values in the account, along with the change value of the transaction, and update the account balance to the updated account balance.

37. The computer server according to claim 36, wherein the processing circuitry is configured to update the account balance conditioned on not detecting a concurrent transaction involving the account and is further configured to abort updating the account balance and restart recordation of the transaction against the account in response to detecting a concurrent transaction.

38. The computer server according to claim 31, wherein the processing circuitry is configured to lock the account against concurrent transactions in response to determining to record the transaction using the balance updating procedure, and perform the balance updating procedure, in which the processing circuitry updates the account balance of the account to reflect the change value of the transaction and then unlocks the account.

39. The computer server according to claim 21, wherein the processing circuitry is configured to determine whether the transaction is a candidate for use of the delta logging procedure by determining whether a type of the transaction matches one or more transaction types for which use of the delta logging procedure is disallowed.

40. The computer server according to claim 31, wherein the processing circuitry is configured to determine whether the transaction is a candidate for use of the delta logging procedure by determining whether the change value of the transaction exceeds a defined amount.
